(19) United States
(12) Patent Application Publication
(10) Pub. No.: US 2012/0054618 A1
(43) Pub. Date: Mar. 1, 2012

(54) Interactive Trailers

(76) Inventor: Jean A. Ames, Santa Monica, CA (US)

(21) Appl. No.: 12/868,615

(22) Filed: Aug. 25, 2010

(51) Int. Cl. G06F 3/00; G06F 15/16

(52) U.S. Cl. 715/723; 709/231

(57) ABSTRACT

A system and method for providing at least one interactive data drive content that simultaneously displays at least one movie trailer and associated information generated utilizing a user input based on current time-frame is disclosed. The system comprises a GUI including a trailer area and an information panel defined in response to the functionality of the interactive data drive content. The information panel includes a fact box area and a play control area. The trailer area is configured to display the movie trailer and a user can select at least one hot spot on the trailer area to display the respective information along with hyperlinks, on the fact box area without interrupting the movie trailer. The system further includes a means for gathering and tracking at least one analytic data and at least one server configured to provide information responsive to the user input to the GUI.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to movie trailers, and more particularly to an interactive trailer system and method for providing interactive data drive content, that simultaneously displays the movie trailer and associated information generated utilizing a user input.

### DISCUSSION OF RELATED ART

In recent years, motion picture industries promote their films through movie trailers, which are played on various interactive network systems. The movie previews or trailers have been extensively used as a means of stimulating the interest of viewers in the purchase of tickets to view the movies. The trend of watching movie videos or trailers online has increased drastically at a phenomenal rate. With this increase in demand, presenting the movie trailers in an innovative and interactive way to viewers has become a great challenge. Interactive trailers will integrate social media feeds to allow user interaction providing viewers one-click access to characters in the movie.

One of the prior art teaches an AIR Interactive trailer built using the Adobe AIR platform which is used on the movie “Avatar”. The viewers can view the movie trailer in a video area and interact with the trailer effectively. The viewer can click on a character in the trailer in order to unlock additional content. However, when the viewer interacts with the features in AIR trailers, the entire trailer stops to allow the interactive content to be viewed on screen thereby causing an interruption to the movie trailer. Moreover, the AIR trailer requires the viewer to download a special software application to run the trailer.

U.S. Pat. No. 5,949,411 issued to Doerr on Sep. 7, 1999 provides a system for previewing movies, videos, music, and other events, having a host data processing network connected via modem with one or more media companies, and with one or more remote kiosks to transmit data between the media companies and the kiosks, so that the data can be accessed by users at the remote kiosks. A touch screen and user-friendly graphics encourage use of the system. The system enables the user to select the films to be previewed and provides a choice of other information relating to the film, all of which is available through a user-friendly, graphical user-interface (GUI). However, the movie preview stops to navigate to another webpage to display the information requested by the user.

U.S. Pat. No. 6,668,377 issued to Dunn on Dec. 9, 1986 includes an interactive entertainment network system has a video-on-demand (VOD) application which enables viewers to select criteria for grouping various video content programs (e.g., movies, games, TV shows, etc.) into manageable sets for convenient review. Once grouped, the previews or “trailers” for the set of programs are displayed. The VOD application permits the viewer to browse the trailers at their own rate, skipping forward to the next trailer or backward to the previous trailer. If the viewer settles on a particular program, the VOD application also allows the user to rent the program immediately from the trailer being displayed on their television set, without returning to a menu or other order screen. Such a system demands the installation of a VOD application to watch the videos and the viewer does not have a one-click access to the content of the video being played.

Therefore, there is a need for an interactive trailer system that simultaneously displays the movie trailer and associated information generated utilizing a user input. Such a system would not require the installation of separate software to view the trailer. Moreover, such a system would facilitate the user to select a particular point on the trailer area to display the respective information on a lower portion of the trailer screen without interrupting the movie trailer. The present invention accomplishes these objectives.

### SUMMARY OF THE INVENTION

The present invention is an interactive trailer system designed and configured for providing at least one interactive data drive content that simultaneously displays at least one movie trailer and associated information generated utilizing at least one user input based on current time-frame. The at least one interactive data drive content may be configured by means of XML files. The system comprises a graphical user interface (GUI) including a trailer area and an information panel defined in response to the functionality of the at least one interactive data drive content. The trailer area is configured to display the at least one movie trailer. The information panel includes a fact box area and a play control area. The information panel further includes an advertisement space area, a share panel button, a ticket panel button and a settings panel button.

The system facilitates at least one user to select at least one hot spot on the trailer area to display the respective information along with hyperlinks on the information panel without interrupting the at least one movie trailer. The information corresponding to each hot spot is displayed in separate fact boxes in the fact box area. The fact boxes descend from under the play control area into the fact box area and form a stack that is scrollable with the scroll bar and the plurality of arrow buttons. The at least one user can select the hyperlink that navigates to a webpage providing respective additional information. Each fact box further includes a plus sign button that expands the fact box allowing the at least one user to read longer passages of the information and a minus sign button that contracts the fact box.

The system further includes at least one server configured to provide information responsive to the at least one user input to the GUI and a means for gathering and tracking at least one analytic data that corresponds to the at least one hot spot on the trailer area. The server may be a progressive download capable Hyper Text Mark-up Language (HTML) server or a streaming Simple Transportation Management Protocol (STMP) capable server. The means for gathering and tracking the at least one analytic data may be a Google Analytics techniques or a custom interface implemented with MySQL and PHP. The at least one analytic data and user input are utilized to display product information and external web links on the at least one information panel with access to behind the scenes video segment.

### DESCRIPTION OF THE DRAWINGS

FIG. 1 is a diagrammatic representation of an interactive trailer system according to the present invention;

FIG. 2 is an exemplary screen illustration of the present invention, illustrating the preloading of a program that loads quickly and displays progress as a main program is loaded;

FIG. 3 is an exemplary screen illustration of the present invention, illustrating the loading of a GUI including a trailer area and an information panel wherein at least one user is prompted to select a play button on the trailer area to play at least one movie trailer;

FIG. 4 is an exemplary screen illustration of the present invention, illustrating the GUI loaded with the at least one movie trailer on the trailer area;

FIG. 5 is an exemplary screen illustration of the present invention, illustrating at least one hot spot on the trailer area and a fact box area displaying the respective information along with hyperlinks without interrupting the at least one movie trailer;

FIG. 6 is an exemplary screen illustration of the present invention, illustrating a music information button that allows the at least one user to view the information of a song being played along with the at least one movie trailer, on a fact box area without interrupting the at least one movie trailer;

FIG. 7 is an exemplary screen illustration of the present invention, illustrating a share panel button that allows the at least one user to share the at least one movie trailer through email, Embed and other social networks;

FIG. 8 is an exemplary screen illustration of the present invention, illustrating a ticket panel button that allows the at least one user to view icons of various ticket sources and to reserve ticket for a movie of the at least one movie trailer;

FIG. 9 is an exemplary screen illustration of the present invention, illustrating a settings panel button that allows the at least one user to adjust extended settings such as alternate audio tracks of the at least one movie trailer;

FIG. 10 is an exemplary screen illustration of the present invention, illustrating an end screen having a replay button and a reveal all button;

FIG. 11 is a control flow diagram illustrating a high-level operation of an interactive trailer system; and

FIG. 12 is an exemplary screen illustration of another embodiment of the present invention, illustrating a touch screen having a trailer area configured to play at least one movie trailer and an information panel.

### DETAILED DESCRIPTION OF THE PREFERRED EMBODIMENT

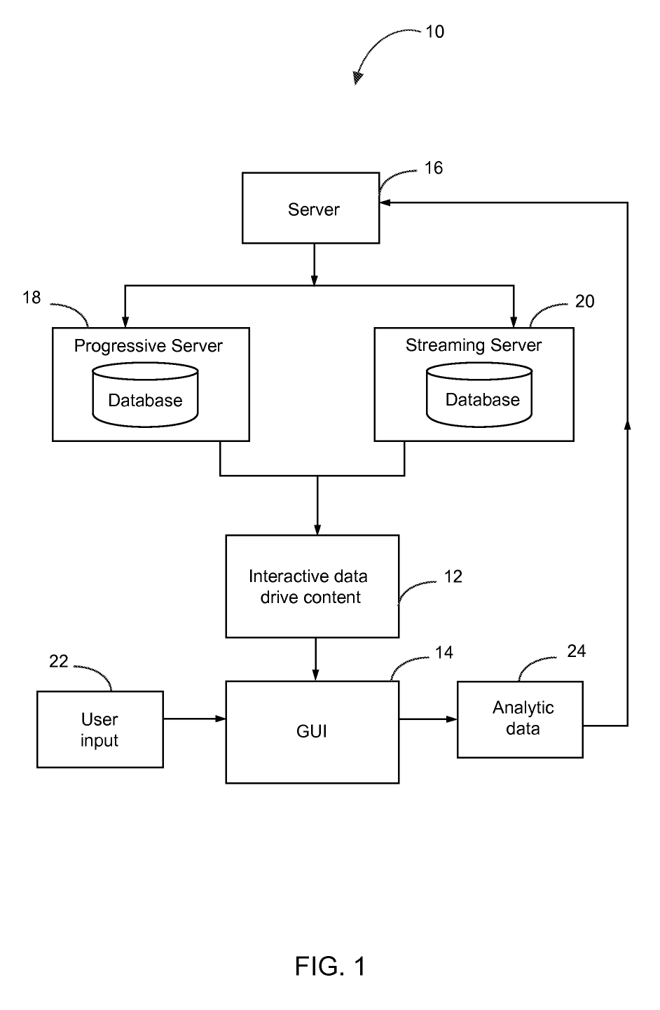

FIG. 1 is a diagrammatic representation of an interactive trailer system 10. The system 10 is designed and configured for providing at least one interactive data drive content 12 that simultaneously displays at least one movie trailer and associated information generated utilizing at least one user input based on current time-frame. The at least one interactive data drive content 12 may be configured by means of XML files. The system 10 comprises a graphical user interface (GUI) 14 including a trailer area and an information panel defined in response to the functionality of the at least one interactive data drive content 12. The trailer area is configured to display the at least one movie trailer. The information panel includes a fact box area and a play control area. The system 10 facilitates at least one user to select at least one hot spot on the trailer area to display the respective information along with hyperlinks on the information panel without interrupting the at least one movie trailer. The information is stacked up on one another in the fact box area and can be browsed using a scroll bar and a plurality of arrow buttons.

The system 10 further includes at least one server 16 configured to provide information responsive to the at least one user input 22 to the GUI 14 and a means for gathering and tracking at least one analytic data 24 that corresponds to the at least one hot spot on the trailer area. The server 16 may be a progressive download capable Hyper Text Mark-up Language (HTML) server 18 or a streaming Simple Transportation Management Protocol (STMP) capable server 20. The means for gathering and tracking the at least one analytic data 24 may be a Google Analytics techniques or a custom interface implemented with MySQL and PHP. The at least one analytic data 24 and user input 22 are utilized to display product information and external web links on the at least one information panel with access to behind the scenes video segment.

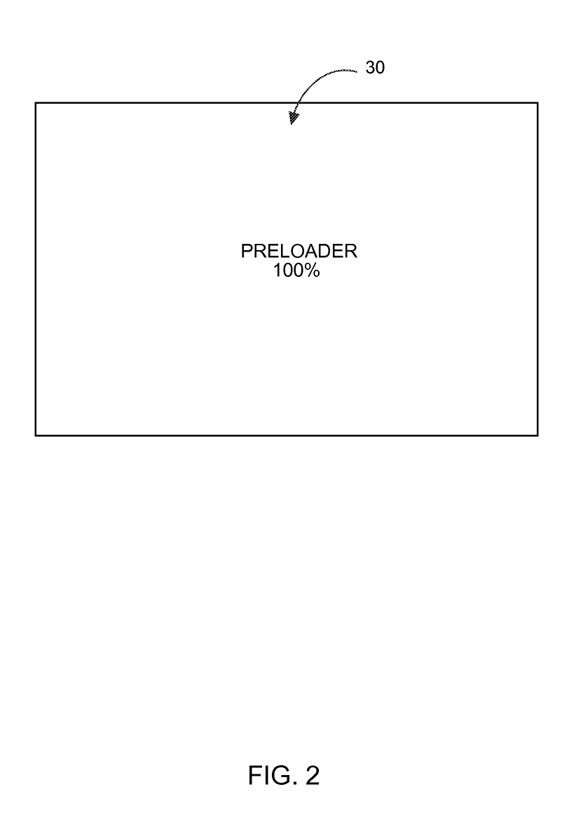

FIG. 2 is an exemplary screen illustration of the present invention, illustrating the preloading of a program 30 that loads quickly and displays progress as a main program is loaded. The preloading program and the main program may be a Flash program, HTML program or an Objective-C program. Small Web Format (SWF) functions as a dominant format for displaying the at least one movie trailer. A plurality of parameters is passed from embed code to the main application when the loading process is completed. An external logo graphic is loaded during the preloading process.

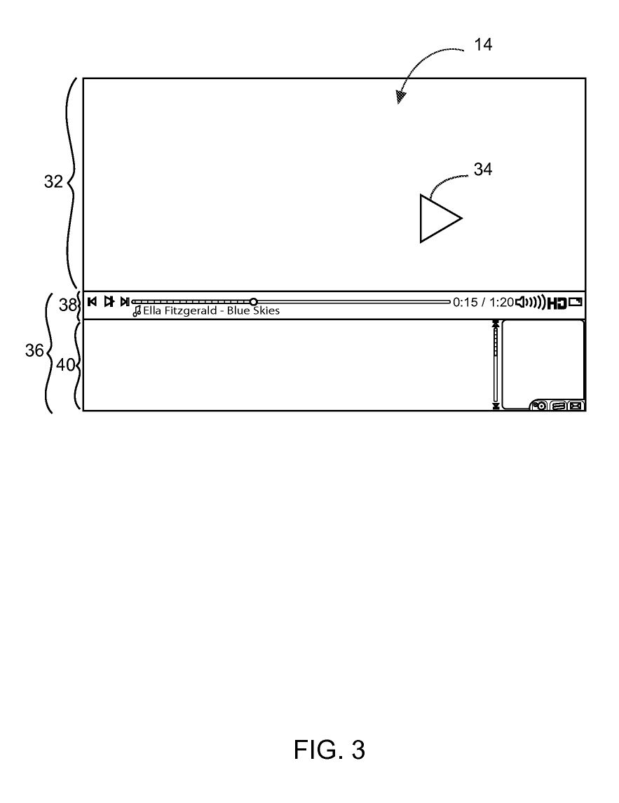

FIG. 3 is an exemplary screen illustration of the present invention, illustrating the loading of the graphical user interface (GUI) 14 including the trailer area 32 and the information panel 36 wherein the at least one user is prompted to select a play button 34 on the trailer area 32 to play the at least one movie trailer. The information panel 36 includes the play control area 38 and the fact box area 40. Loading process initializes by loading the XML configuration file and configures the system 10 based on a plurality of elements such as GUI elements size and location.

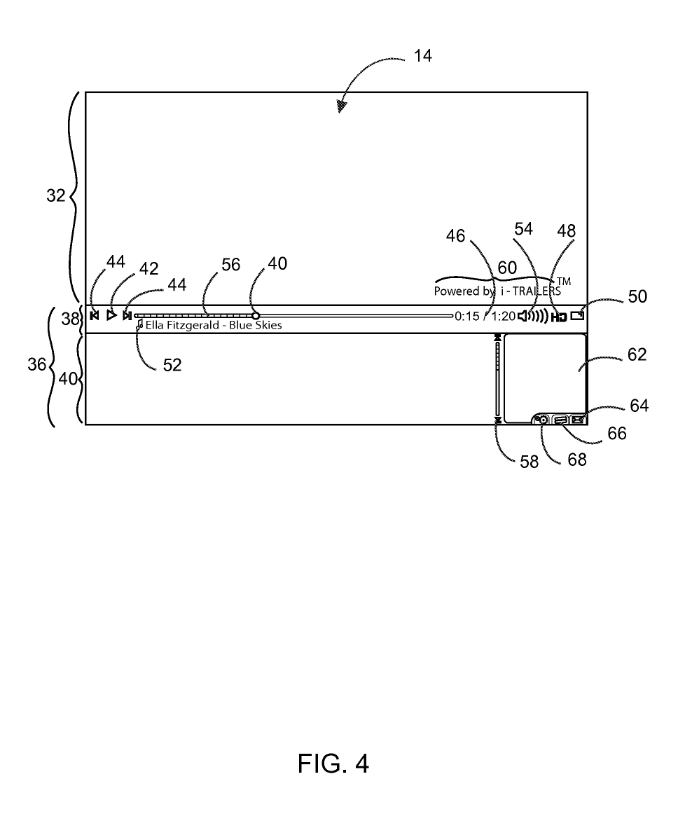

FIG. 4 is an exemplary screen illustration of the present invention, illustrating the GUI 14 loaded with the at least one movie trailer on the trailer area 32. The play control area 38 includes a playhead knob 40 indicating the at least one movie trailer position by means of color cues, a play/pause toggle button 42 allowing the at least one user to start/temporarily interrupt the at least one movie trailer, a plurality of fact buttons 44 allowing the at least one user to rewind and forward the at least one movie trailer and a time display button 46 displaying current time and total time of the at least one movie trailer, a high definition button 48 allowing the at least one user to view high definition version of the at least one movie trailer, a full screen toggle button 50 allowing the at least one user to watch the at least one movie trailer in full screen and a music information button 52 allowing the at least one user to view the information of a song being played with the at least one movie trailer on the fact box area 40.

The play control area 38 further includes a volume slider 54 to adjust the volume of the at least one movie trailer and a time line 56 that indicates the length of the at least one movie trailer, the current movie trailer position, the amount of the movie trailer loaded and the amount of movie trailer remaining. The fact box area 40 displays the information responsive to the at least one hot spot on the trailer area 32. The displayed information can be browsed using a scroll bar and a plurality of arrow buttons 58. The at least one user can acquire more information about the company and the associated movie trailers by selecting a company link 60 provided on the trailer area 32.

The information panel 36 further includes an advertisement space area 62 allowing the at least one user to view subordinate contents, a share panel button 64 allowing the at least one user to share the at least one movie trailer through email, embed and other social networks, a ticket panel button 66 allowing the at least one user to view icons of various ticket sources and to reserve ticket for a movie of the at least one movie trailer and a settings panel button 68 allowing the at least one user to adjust extended settings such as alternate audio tracks of the at least one movie trailer.

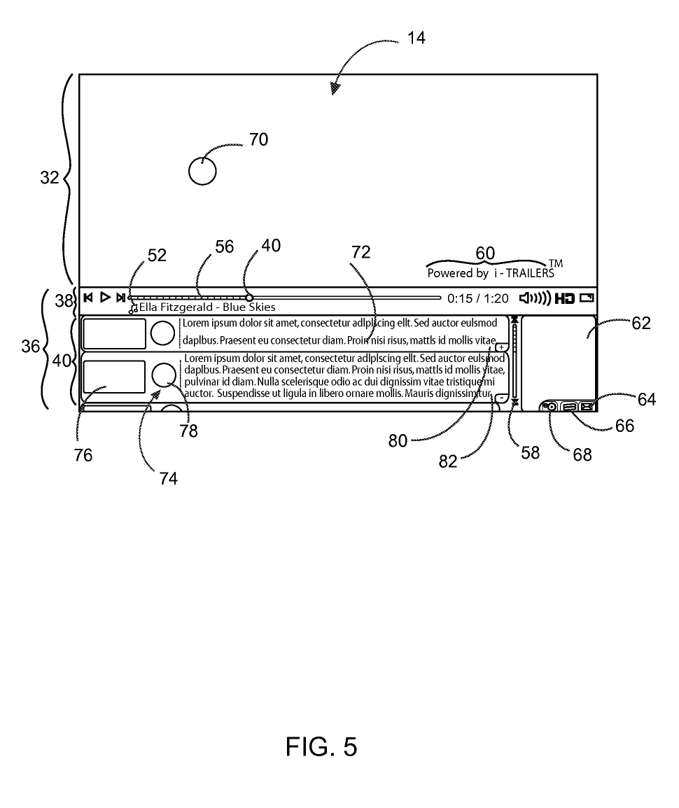

FIG. 5 is an exemplary screen illustration of the present invention, illustrating the at least one hot spot 70 on the trailer area 32 and the fact box area 40 displaying the respective information along with hyperlinks 72 without interrupting the at least one movie trailer. The information corresponding to each hot spot 70 is displayed in separate fact boxes 74 in the fact box area 40. The information can be character/story oriented, trivia or location. The fact boxes 74 descend from under the play control area 38 into the fact box area 40 and form a stack that is scrollable with the scroll bar and the plurality of arrow buttons 58. The fact box 74 includes a still frame 76 of the at least one movie trailer and a fact box type icon 78 that indicates the category of fact box 74. The at least one user can select the hyperlink 72 that navigates to a webpage providing respective additional information. Each fact box 74 further includes a plus sign button 80 that expands the fact box 74 allowing the at least one user to read longer passages of the information and a minus sign button 82 that contracts the fact box 74.

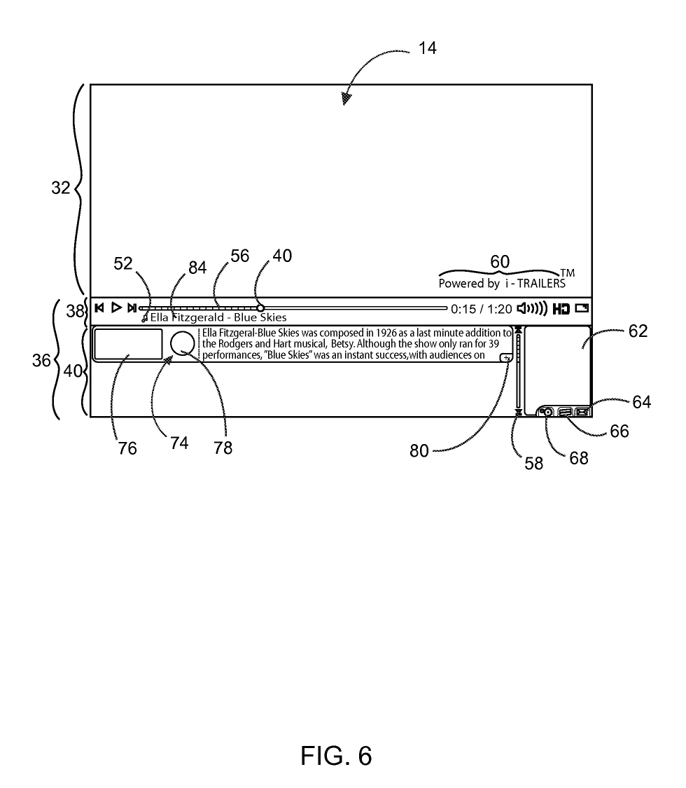

FIG. 6 is an exemplary screen illustration of the present invention, illustrating the music information button 52 that allows the at least one user to view the information of a song being played along with the at least one movie trailer, on the fact box area 40 without interrupting the at least one movie trailer. The title of the song 84 being played is displayed next to the music information button 52.

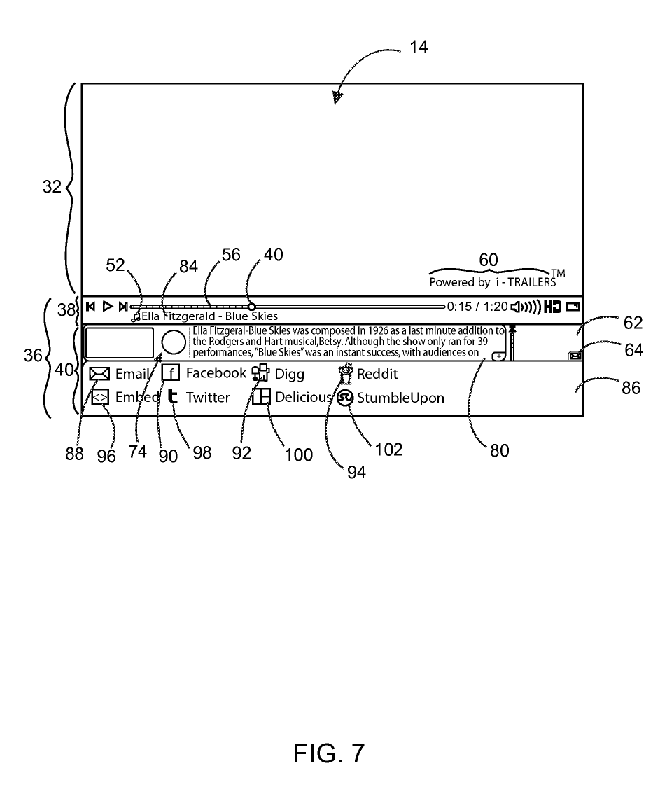

FIG. 7 is an exemplary screen illustration of the present invention, illustrating the share panel button 64 that allows the at least one user to share the at least one movie trailer. The at least one user can click on the share panel button 64 to pop up a share panel 86 that includes sub links such as Email 88, Facebook 90, Digg 92, Reddit 94, Embed 96, Twitter 98, Delicious 100 and StumbleUpon 102. The sub links 88, 90, 92, 94, 96, 98, 100, 102 have different functions such as providing pop ups to copy embed code, email a link to friends and broadcast a link to the program over various social networking sites. The share panel button 64 can be contracted back to its original position by clicking once again on the share panel button 64.

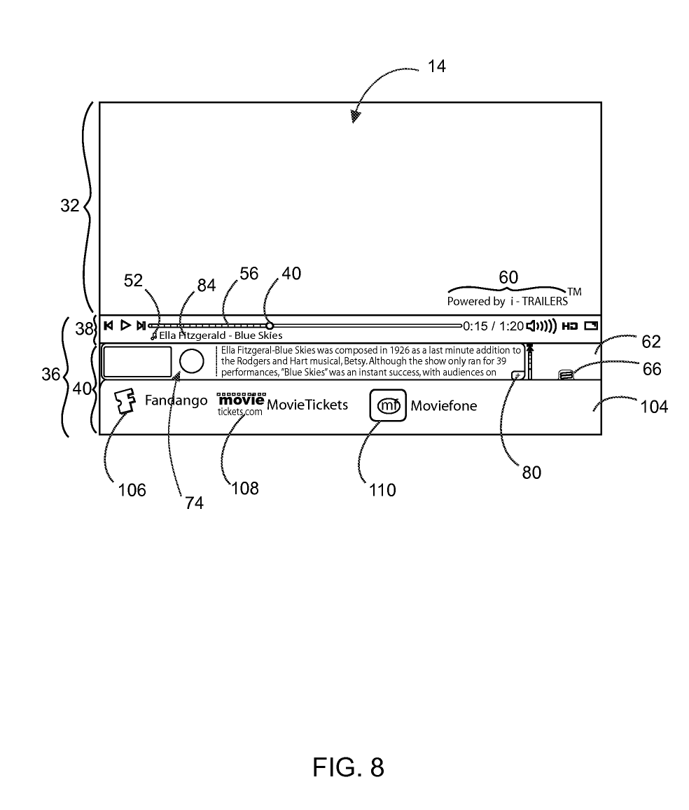

FIG. 8 is an exemplary screen illustration of the present invention, illustrating the ticket panel button 66 that allows the at least one user to view icons of various ticket sources and to reserve ticket for a movie of the at least one movie trailer. The at least one user can click on the ticket panel button 66 to pop up a ticket panel 104 that includes sub links such as Fandango 106, MovieTickets 108 and Moviefone 110. The tickets can be purchased at various online ticketing websites. The ticket panel button 66 can be contracted back to its original position by clicking once again on the ticket panel button 66 by the at least one user.

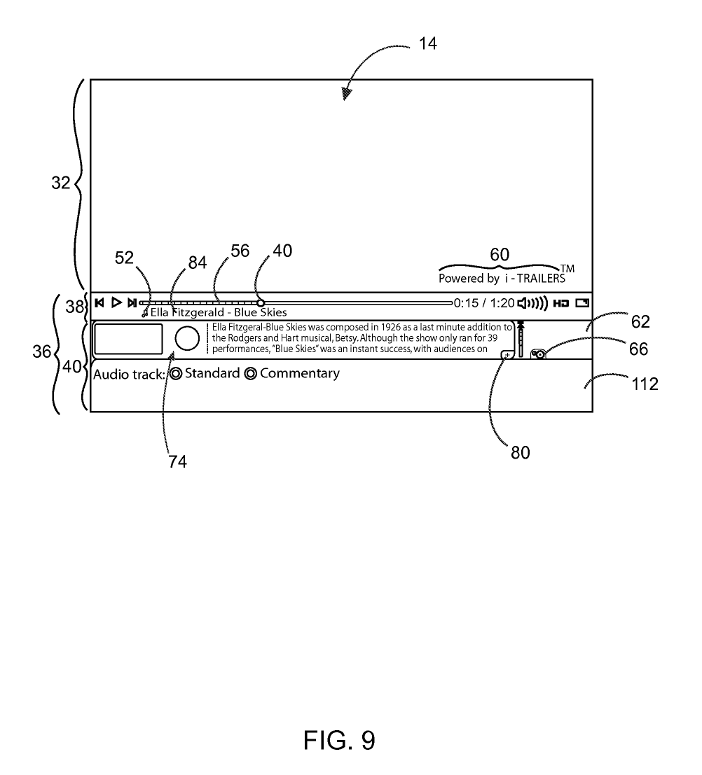

FIG. 9 is an exemplary screen illustration of the present invention, illustrating the settings panel button 68 that allows the at least one user to adjust extended settings such as alternate audio tracks of the at least one movie trailer. The at least one user can click on the settings panel button 68 to pop up a settings panel 112 that provides options to change various settings particular to the implementation of the system 10. The settings panel button 68 can be contracted back to its original position by clicking once again on the settings panel button 68 by the at least one user.

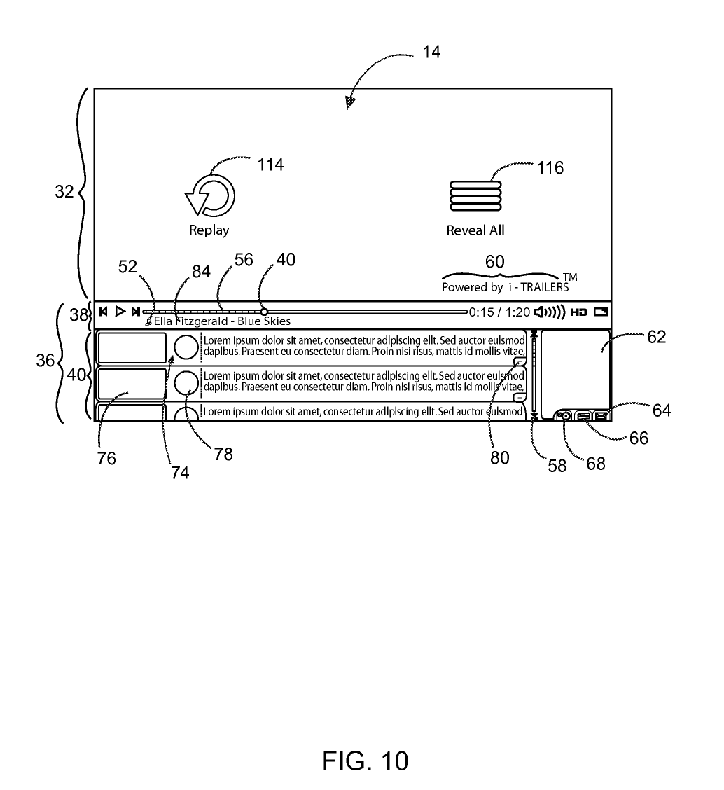

FIG. 10 is an exemplary screen illustration of the present invention, illustrating an end screen having a replay button 114 and a reveal all button 116. The replay button 114 allows the at least one user to restart the at least one movie trailer from the beginning and the reveal all button 116 allows the at least one user to view all available fact boxes 74 displayed in the fact box area 40, regardless of whether or not the at least one user has selected the fact boxes 74.

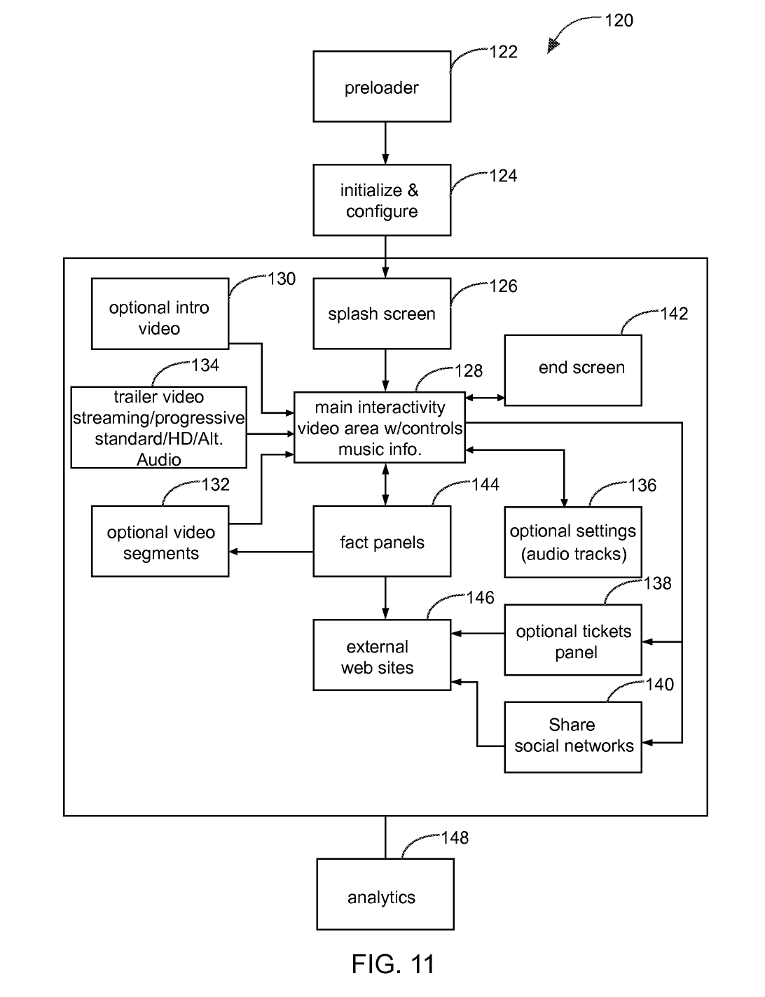

FIG. 11 is a control flow diagram 120 illustrating a high-level operation of the interactive trailer system 10. The at least one user invokes the interactive trailer system 10 for providing at least one interactive data drive content 12 that simultaneously displays at least one movie trailer and associated information generated utilizing at least one user input 22 based on current time-frame. Processing begins at step 122 by preloading the program that loads quickly and displays progress as the main program is loaded. A plurality of parameters is passed to the main application when the loading process is completed. Continuing to step 124, the loading process initializes by loading the XML configuration files and configuring the system to a plurality of elements such as GUI elements size and location. Continuing to step 126, the GUI 14 having the trailer area 32 with the play button 34 and the information panel 36 is loaded completely. The at least one user can select the play button 34 to play the at least one movie trailer.

Continuing to step 128, the at least one movie trailer is loaded on the trailer area 32 and the at least one user interacts with the at least one movie trailer using the play control area 38 provided on the information panel 36. Prior to the loading of the at least one movie trailer, introduction video or at least one video segment may be loaded on the trailer area 32 based on the configuration of the system 10 as indicated in steps 130 and 132 respectively. The introduction video will reveal instructions to the at least one user about the selection of the at least one hot spot 70 on the trailer area 32 to display the respective information. The at least one interactive data drive content 12 for displaying at least one movie trailer is configured by means of XML files such as a video source (progressive/streaming) and a video format (standard/HD/Alternate Audio) as indicated in step 134.

Referring again to step 128, the at least one user interacts with the at least one movie trailer using the share panel 86, the ticket panel 104 and the settings panel 112 on the information panel 36. The at least one user can adjust the settings (audio tracks) of the at least one movie trailer by using the settings panel 112 as indicated in step 136. The at least one user can reserve tickets for the at least one movie trailer using the ticket panel 104 and can also share the at least one movie trailer through various social networks or external websites using the share panel 86 as indicated in steps 138 and 140. If the at least one user views the at least one movie trailer without migrating to the steps 130-140, the step 128 immediately proceeds to step 142. In step 142, the at least one user can restart the at least one movie trailer from the beginning and view all available fact boxes 74 displayed in the fact box area 40. The at least one user can go through each information in the fact boxes 74 and selecting the information will pop up the respective section of the at least one movie trailer on the trailer area 32.

Referring again to step 128, the at least one user can select the at least one hot spot 70 on the trailer area 32 to display the respective information along with hyperlinks 72 on the fact box area 40 in the information panel 36. The information with respect to each hot spot 70 is displayed in separate fact boxes 74 in the fact box area 40 as indicated in step 144. Continuing to step 146, the at least one user can select the hyperlinks 72 that navigates to a webpage providing respective additional information.

At least one analytics process, indicated in step 148, is used for processing the steps 126-146. In step 148, the at least one analytics process is initialized utilizing the plurality of parameters and the user input data thereby configuring the at least one interactive data drive content 12. The means for gathering and tracking the at least one analytic data 24 that corresponds to the user input 22 is provided and the at least one analytic data 24 is utilized to display information about the at least one movie trailer on the information panel 36.

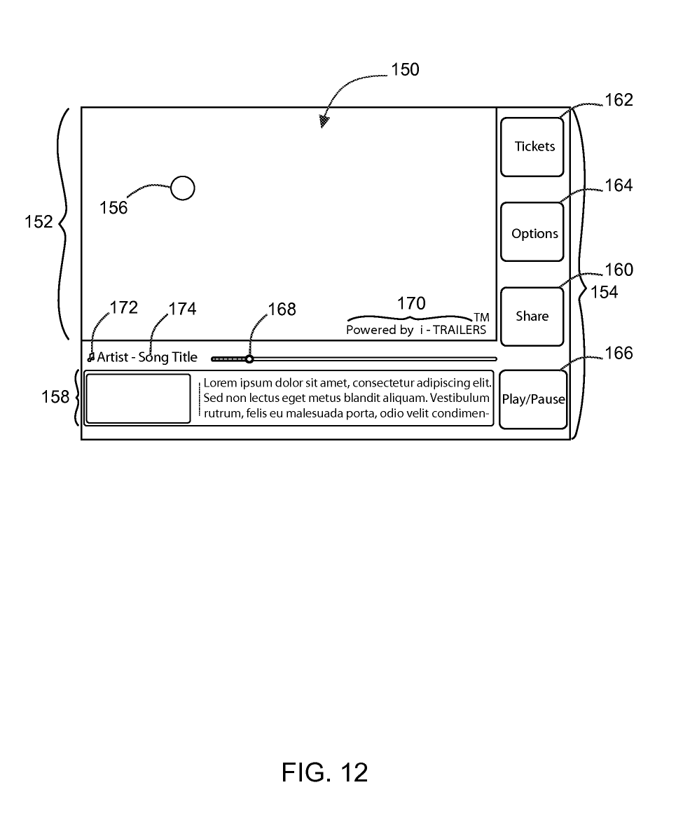

FIG. 12 is an exemplary screen illustration of another embodiment of the present invention, illustrating a touch screen 150 having a trailer area 152 configured to play at least one movie trailer and an information panel 154. The at least one user can select at least one hot spot 156 on the trailer area 152 by using their fingers to generate respective information on a fact box area 158 of the information panel 154. Similarly, the embodiment provides options for the at least one user to share the at least one movie trailer using a share panel button 160, to reserve ticket for a movie of the at least one movie trailer using a ticket panel button 162 and to adjust extended settings such as alternate audio tracks of the at least one movie trailer by using an option button 164.

The touch screen 150 includes a play/pause toggle button 166 that allows the at least one user to start/temporarily interrupt the at least one movie trailer and a playhead knob 168 indicating the at least one movie trailer position by means of color cues. The touch screen 150 further includes a company link 170 that allows the at least one user to acquire more information about the company and the associated movie trailers and a music information button 172 that allows the at least one user to view the information of a song being played along with the at least one movie trailer. The title of the song 174 being played is displayed next to the music information button 172.

While a particular form of the invention has been illustrated and described, it will be apparent that various modifications can be made without departing from the spirit and scope of the invention. For example, the system may include interactive network systems such as computer system, iPads or mobile devices. Accordingly, it is not intended that the invention be limited, except as by the appended claims.

What is claimed is:

1. A system designed and configured for providing at least one interactive data drive content that simultaneously displays at least one movie trailer and associated information generated utilizing at least one user input based on current time-frame, the system comprising:
a graphical user interface (GUI) including a trailer area and an information panel defined in response to the functionality of the at least one interactive data drive content;
at least one server configured to provide information responsive to the at least one user input to the GUI; and
a means for gathering and tracking at least one analytic data that corresponds to at least one hot spot on the trailer area;
whereby the at least one analytic data and user input are utilized to display product information and external web links on the at least one information panel with access to behind the scenes video segment.

2. The system of claim 1 wherein the trailer area is configured to display the at least one movie trailer.

3. The system of claim 1 wherein the information panel includes a fact box area and a play control area.

4. The system of claim 1 wherein the system facilitates at least one user to select the at least one hot spot on the trailer area to display the respective information along with hyperlinks on the fact box area of the information panel without interrupting the at least one movie trailer.

5. The system of claim 4 wherein the information is stacked up on one another and can be browsed using a scroll bar and a plurality of arrow buttons.

6. The system of claim 1 wherein the at least one interactive data drive content may be configured by means of XML files.

7. The system of claim 1 wherein the server may be a progressive download capable Hyper Text Mark-up Language (HTML) server.

8. The system of claim 1 wherein the server may be a streaming Simple Transportation Management Protocol (STMP) capable server.

9. The system of claim 1 wherein the means for gathering and tracking the analytic data may utilize Google Analytics techniques.

10. The system of claim 1 wherein the means for gathering and tracking the analytic data may utilize custom interface implemented with MySQL and PHP.

11. A method for providing at least one interactive data drive content that simultaneously displays at least one movie trailer and associated information generated on a system utilizing at least one user input based on current time-frame, the method comprising the steps of:
a) providing a graphical user interface (GUI) that includes a trailer area and an information panel;
b) preloading a program that loads quickly and displays progress as a main program is loaded;
c) passing a plurality of parameters to a main application when the loading process is completed;
d) initializing and configuring a plurality of elements associated to the system;
e) loading the GUI and prompting at least one user to play the at least one movie trailer;
f) initializing at least one analytics process utilizing the plurality of parameters to load the at least one movie trailer;
g) loading the at least one movie trailer;
g) selecting at least one hot spot on the trailer area to display the respective information on the information panel;
h) initializing at least one analytics process utilizing a user input data thereby configuring the at least one interactive data drive content; and
i) displaying the information as stacks without interrupting the at least one movie trailer.

12. The method of claim 11 wherein the stacked information can be browsed using a scroll bar and a plurality of arrow buttons.

13. The method of claim 11 wherein the at least one interactive data drive content may be configured by means of XML files.

14. The method of claim 11 wherein the program and main program may be a Flash program.

15. The method of claim 11 wherein the program and main program may be a HTML program.

16. The method of claim 11 wherein the program and main program may be an Objective-C program.

17. The method of claim 11 wherein the at least one analytics process may utilize Google Analytics techniques.

18. The method of claim 11 wherein the information responsive to the at least one hot spot on the trailer area is provided based on at least one server.

19. The method of claim 18 wherein the server may be a progressive download capable (Hyper Text Mark-up Language) HTML server.

20. The method of claim 18 wherein the server may be a streaming Simple Transportation Management Protocol (STMP) capable server.
